(19) United States
(12) Patent Application Publication
(10) Pub. No.: US 2008/0297666 A1
(43) Pub. Date: Dec. 4, 2008

(54) System and Method for Increasing the Brightness of an Image

(75) Inventor: Brent Hoffman, Mooresville, IN (US)

Correspondence Address: FLETCHER YODER P.C., 7915 FM 1960 RD. WEST, SUITE 330, HOUSTON, TX, 77070, US

(73) Assignee: TTE TECHNOLOGY, INC., Indianapolis, IN (US)

(21) Appl. No.: 12/066,486

(22) PCT Filed: Sep. 21, 2005
(86) PCT No.: PCT/US05/33935

§ 371 Date: Mar. 11, 2008

(51) Int. Cl. H04N 9/12; H04N 9/31

(52) U.S. Cl. 348/743; 348/744

(57) ABSTRACT

The disclosed embodiments relate to a system and method for increasing the brightness of a video image. More specifically, there is provided a video unit (10) comprising a color wheel (14), a light source (12) configured to project a light beam at the color wheel (14), and a video control system (18) coupled to the color wheel (14) and the light source (12) and configured to decrease a supply current level for the light source (12) below a first current level during a spoke time of the color wheel (14) and to increase the supply current level above the first current level during a non-spoke time of the wheel (14).

### FIELD OF THE INVENTION

The present invention relates generally to projecting video images onto a screen. More specifically, the present invention relates to a system for increasing the brightness of a projected video image.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Many types of video display units employ high intensity light sources, such as metal halide lamps, mercury vapor lamps, and the like. In a typical video display unit, the light generated from the high intensity light source passes through a color wheel that converts the stream of white light generated by the high intensity light source into a stream of light that rapidly and repeatedly changes from red light to green light to blue light. The video display unit may use this red, green, and blue light to create a red image, a green image, and a blue image, which are each projected onto a screen. Because the red, green, and blue images are displayed in relatively quick succession, a person watching the video display unit sees a single video image formed from the red image, the green image, and the blue image.

As described above, the color wheel within a typical video display unit converts the stream of white light produce by a light source into a stream of rapidly changing colored light. In a typical video unit, the color wheel includes six color filters arrayed red-green-blue-red-green-blue in arcuate regions around the outside of the color wheel. As the color wheel rotates, there are six periods of time when the white light from the light source is transitioning from one color filter to the next color filter. These time periods are referred to as the spoke times. During the spoke times, the light shining from the color wheel is not a pure primary color, and therefore may not be usable by the video display unit to project a video image. As such, the imaging system within a typical video unit may be configured to discard the light generated during the spoke time. For example, in a digital light processing (“DLP”) system, the digital micromirror device (“DMD”) maybe configured to turn off during the spoke times.

The lamps within the above-described high intensity light sources are typically designed to operate at or below a particular average power rating. Exceeding the pre-set average power threshold for the lamp can reduce the life span of functionality of the light source. Conventional video display units provide a constant supply current to the light source during the entire revolution of the color wheel and just discard the light generated during the spoke times.

Embodiments of the present invention may relate to a system and a method for boosting the brightness of a video without exceeding a particular average power level for a light source.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the disclosed invention relate to a system and method for increasing the brightness of a video image. More specifically, there is provided a video unit comprising a color wheel, a light source configured to project a light beam at the color wheel, and a video control system coupled to the color wheel and the light source and configured to decrease a supply current level for the light source below a first current level during a spoke time of the color wheel and to increase the supply current level above the first current level during a non-spoke time of the wheel.

### BRIEF DESCRIPTION OF THE DRAWINGS

Advantages of the invention may become apparent upon reading the following detailed description and upon reference to the drawings in which:

FIG. 1 is a block diagram of a video unit configured to increase the brightness of an image in accordance with embodiments of the present invention;

FIG. 2 is a diagram of a color wheel configured to increase the brightness of an image in accordance with embodiments of the present invention; and

FIG. 3 is a flow chart illustrating an exemplary technique for increasing the brightness of an image in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, is numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

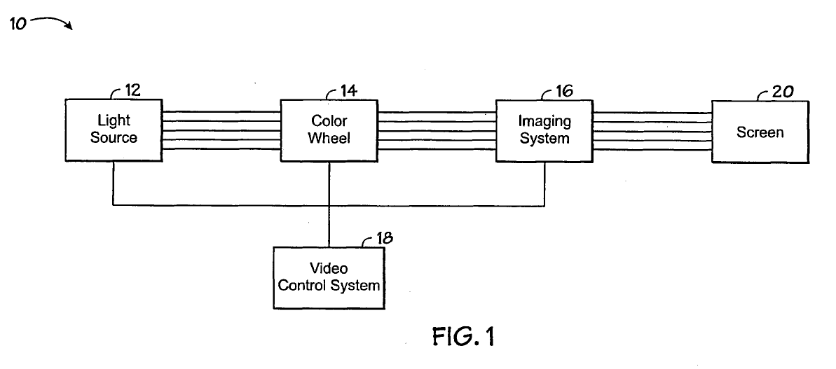

Turning initially to FIG. 1, a block diagram of a video unit configured to increase the brightness of a video image in accordance with one embodiment is illustrated and generally designated by a reference numeral 10. In one embodiment, the video unit 10 may comprise a Digital Light Processing (“DLP”) projection television or projector. In another embodiment, the video unit 10 may comprise a liquid crystal diode (“LCD”) projection television. In still other embodiments, the video unit 10 may comprise another suitable form of projection television or display.

The video unit 10 may comprise a light source 12. The light source 12 may include any suitable form of lamp or bulb capable of projecting white or generally white light. In one embodiment, the light source 12 may be a high intensity light source, such as a metal halide lamp or a mercury vapor lamp. For example, the light source 12 may be an ultra high performance (“UHP”) lamp produced by Phillips Electronics. In one embodiment, the light source 12 is configured to project, shine, or focus the generally white light into one static location as described further below.

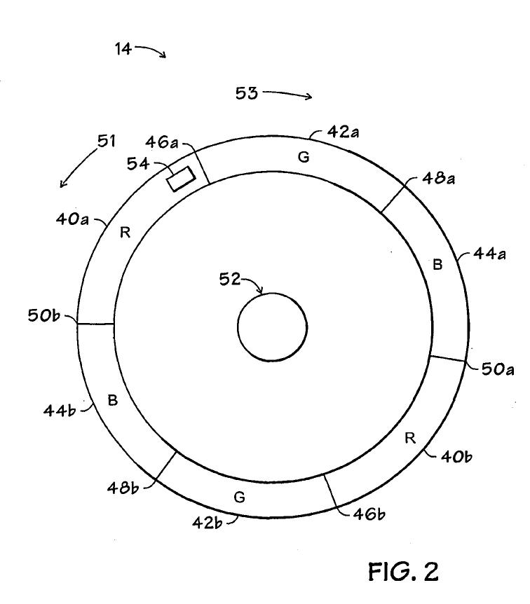

As illustrated in FIG. 1, the exemplary video unit 10 also includes a color wheel 14 aligned in an optical line of sight of the light source 12. Accordingly, FIG. 2 is a diagram of the color wheel 14 configured to increase the brightness of an image in accordance with one embodiment. The color wheel 14 may include a variety of color filters 40a, 40b, 42a, 42b, 44a, and 44b arrayed as arcuate regions on the color wheel 14. In the illustrated embodiment, the color wheel 14 comprises color filters 40a, 40b, 42a, 42b, 44a, and 44b configured to convert generally white light into one of the three primary colors of light: red, green, or blue. In particular, the illustrated embodiment of the color wheel 14 comprises two red color filters 40a and 40b, two green color filters 42a and 42b, and two blue color filters 44a and 44b. It will be appreciated that in alternate embodiments, the specific colors of the filters 40a, 40a, 42a, 42b, 44a, and 44b may be altered or the number of filters may be altered. For example, in one alternate embodiment, the color wheel 14 may comprise only one red color filter 40a, one green color filter 42a, and one blue color filter 44a. In this embodiment, the arcuate regions occupied by the color filters 42a, 44a, and 46a may be approximately twice as long (as measured along the circumference of the color wheel 14) than the color filters 40a, 40b, 42a, 42b, 44a, and 44b depicted in FIG. 2. In still other embodiments, the color filters 40a, 40b, 42a, 42b, 44a, and 44b may occupy either more or less of the surface area of the color wheel depending on the configuration and function of the video unit 10.

In addition, the color wheel 14 may comprise boundaries between each of the filters 40a, 40b, 42a, 42b, 44a, and 44b. These boundaries are known as spokes 46a, 46b, 48a, 48b, 50a, and 50b due to their resemblance to the spokes of wheel. For example, FIG. 2 illustrates three types of spokes: the yellow (i.e., red-green) spokes 46a and 46b, the cyan (i.e., green-blue) spokes 48a and 48b, and the magenta (i.e., blue-red) spokes 50a and 50b.

Turning next to the operation of the color wheel 14, and looking at both FIGS. 1 and 2, each of the filters 40a, 40b, 42a, 42b, 44a, and 44b is designed to convert the white light 28 generated by the light source 12 into colored light 30. In particular, the color wheel 14 may be configured to rapidly spin in a counterclockwise direction 51 around its center point 52. The light source 12 may then be configured to focus generally white light at the color wheel 14. On the opposite side of the color wheel 14 from the light source 12, there may be an imaging system 16. Because the location of the imaging system 16 is fixed and the color wheel 14 rotates, the light that enters the imaging system 16 can be illustrated as a fixed area 54 that rotates around the color wheel 14 in the opposite direction from the color wheel 14 direction of rotation.

For example, as the color wheel 14 rotates in the counterclockwise direction 51, the fixed area 54 rotates through each the filters 40a, 40b, 42a, 42b, 44a, and 44b in the clockwise direction 53. As such, the colored light entering the imaging system 16 rapidly changes from red to green to blue to red to green to blue with each rotation of the color wheel 14 as the fixed area 54 passes through each of the color filters 40a, 40b, 42a, 42b, 44a, and 44b. In other words, because the light source 12 is stationary, the counterclockwise rotation of the color wheel 14 causes the fixed area 54 to rotate in a clockwise direction 53 through the colors of the color wheel 14. In alternate embodiments, the color wheel 14 itself may rotate in the clockwise direction 53. Those skilled in the art will appreciate that the size and shape of the fixed area 54 and the filters 40a, 40b, 42a, 42b are merely illustrative. In alternate embodiments, the size and shape of the fixed area 54 and/or the filters 40a, 40b, 42a, 42b, 44a, 44b may be different depending on the optical design of the system.

As the fixed area 54 passes though each of the spokes 46a, 46b, 48a, 48b, 50a, and 50b, the color of the colored light 30 entering the imaging system 16 is not consistent. In particular, as the fixed area 54 crosses the edge of one particular spoke 46a, 46b, 48a, 48b, 50a, and 50b, the colored light 30 entering the imaging system 16 will comprise two different colors of light. These times (when two different colors of light are entering the imaging system 16) are referred to as “spoke times” and the times when the only a single primary color of light is entering the imaging system 16 are referred to as “non-spoke times.” For example, the percentage of red light will decrease and the percentage of green light will increase as the fixed area 54 moves across the spoke 46a into the green filter 42a until the colored light 30 entering the imaging system 16 consists entirely of green light (i.e., the fixed area 54 crosses completely out of the red filter 40a and wholly into the green filter 42a). The color of the colored light 30 will then remain a consistent green color until the fixed area 54 crosses the spoke 48a. In one embodiment, the spoke times each occupy 15 degrees of the outer circumference of the color wheel 14 and the non-spoke times each occupy 45 degrees of the outer circumference of the color wheel 14.

As described above, because the color of the colored light 30 entering the imaging system 16 is not consistent during the spoke times, the system 10 may be configured to discard the light produced during the spoke times. For example, in a DLP system, all of the micromirrors on the DMD 18 may be turned off during the spoke times.

Returning now to FIG. 1, the red, green, and blue light exiting the color wheel 14 may enter the imaging system 16. The imaging system 16 may be configured to employ the red, green, and blue light to create an image suitable for display on a screen 20. In one embodiment, the imaging system 16 comprises a DLP imaging system that employs one or more DMDs to generate a video image using the red, green, and blue light. In another embodiment, the imaging system 16 may employ an LCD projection system. It will appreciated, however, that the above-describe exemplary embodiments are not intended to be exclusive, and that in alternate embodiments, any suitable form of imaging system 16 may be employed in the video unit 10.

As shown in FIG. 1, the light source 12, the color wheel 14, and the imaging system 16 may also be communicatively coupled to a video control system 18. In one embodiment, the video control system 18 may include one or more processors, associated memory, and/or other suitable control system components. As will be described below, in one embodiment, the video control system 18 may be configured to control the supply current provided to the light source 12.

As described above, the light source 12 may include a high intensity light source, such as a metal halide lamp, a mercury vapor lamp, or a UHP lamp. Conventionally, these types of lamps are powered by a constant supply current or by a near-constant supply current that periodically increases (pulses) to stabilize arcing on the electrodes of the lamp. The video unit 10, on the other hand, may be configured to decrease the supply current to the light source 12 during the spoke times and to increase the supply current to the light source 12 during the non-spoke times such that the average power provided to the light source 12 is approximately equivalent to the average power before altering the supply currents. As such, the average power does not exceed the ratings of the lamp within the light source 12 even though the supply current during the non-spoke times has increased.

In one embodiment, the video control system 18 may be configured to decrease the supply current by fifty percent from a nominal (starting) supply current level during the spoke times and to increase the supply current during the non-spoke times over the nominal supply current by the product of the supply current decrease during the spoke times multiplied by the ratio of the degrees of the color wheel 14 for the spoke times to the degrees on the color wheel 14 for the non-spoke times. For example, in one embodiment, decreasing the spoke time supply current by fifty percent produces a 14.3 percent increase in light output during the spoke times for the color wheel 14 with a 45 degree/15 degree spoke time to non-spoke time ratio.

Because the increase and supply current and the decrease in supply current are related, the average power of the light source 12 remains approximately the same as if the supply current had not been decreased during the spoke times and increased during the non-spoke times. It will be appreciated, however, that the fifty percent decrease in the supply current described above during is merely exemplary. As such, in alternate embodiments, the supply current during the spoke times may be decreased by a different amount as long as the increase in the supply current during the non-spoke times is at least partially based on the decrease in supply current during the spoke times. In one embodiment, a lamp ballast (not shown) within the light source 12 may be configured to automatically increase the supply current to the lamp within the light source 12 during the non-spoke times after a decrease in supply current during the spoke times.

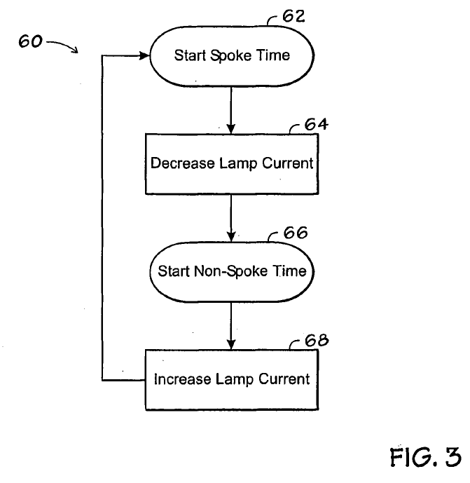

FIG. 3 is a flow chart illustrating an exemplary technique 60 for increasing the brightness of an image in accordance with one embodiment. In one embodiment, the technique 60 may be performed by the video control system 18 in conjunction with the light source 12, the color wheel 14, and the imaging system 16. As illustrated in FIG. 3, the technique 60 may begin when the color wheel 14 starts a spoke time, as illustrated in block 62. Upon the start of the spoke time, the video control system 18 may be configured to decrease the supply current to the lamp within the light source 12, as indicated in block 64. As described above, in one embodiment, the video control system 18 may be configured to decrease the supply current to the light source 12 by fifty percent.

As illustrated by block 66, the supply current to the light source 12 may remain decreased until the color wheel 14 begins one of the non-spoke times. Once the non-spoke time begins the video control system 18 may be configured to increase the supply current to the light source 12 above the nominal (i.e., starting) supply current level by an amount roughly approximate to the decrease in the supply current during the spoke time. In one embodiment, the increase in supply current may result in a 14.3 percent increase in light output from the light source 12 over the nominal supply current. Last, as illustrated in FIG. 3, the technique 60 may cycle back to block 62 when the color wheel 14 starts the next spoke time.

It will also be appreciated that the video unit 10 may employ the technique 60 in conjunction with other brightness-boosting techniques. For example, many types of light sources 12 are periodically pulsed with higher supply currents to stabilize arcing within the lamp of the light source 12. This periodic pulsing of the lamp can also be employed to increase the brightness of the projected image. As such, in one embodiment that employs periodic supply current pulsing, the techniques described herein maybe employed to boost the brightness of light generated during the periodic pulses and/or during the non-pulse times.

Further, the techniques described herein may also be employed in video units 10 that utilize spoke light recovery. Spoke light recovery enables the video unit 10 to use the light generated during spoke times if the shade of light being projected by video unit 10 exceeds a predetermined brightness threshold. Because spoke light recovery techniques utilize the light generated during the spoke times, embodiments of the present technique that also employ spoke light recovery may be configured to not decrease the lamp supply current when the shade of color to be projected at a particular pixel exceeds the predetermined brightness threshold or may be configured to limit the amount of the supply current decrease.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A video unit (10) comprising:
a color wheel (14);
a light source (12) configured to project a light beam at the color wheel (14); and
a video control system (18) coupled to the color wheel (14) and the light source (12) and configured:
to decrease a supply current level for the light source (12) below a first current level during a spoke time of the color wheel (14); and
to increase the supply current level above the first current level during a non-spoke time of the wheel (14).

2. The video unit of claim 1, wherein the video control system (18) is configured to increase the supply current level to a level approximately equal to the product of the first current level and a ratio of the spoke time and the non-spoke time.

3. The video unit of claim 1, wherein the light source (12) comprises a metal halide lamp.

4. The video unit of claim 1, wherein the light source (12) is configured to generate a beam of light utilizing the increased supply current.

5. The video unit of claim 4, comprising an imaging system (16) configured to receive the beam of light and to project an image onto a screen (20) utilizing the beam of light.

6. The video unit of claim 4, wherein the imaging system (16) comprises a digital micromirror device.

7. The video unit of claim 1, wherein the light source (12) comprises a ballast configured to decreasing the supply current level in response to an instruction from the video control system (18).

8. The video unit of claim 1, wherein the video control system (18) is configured to decrease the supply current level by fifty percent.

9. A method comprising:
decreasing a supply current level below a first current level during a spoke time of a color wheel (14); and
increasing the supply current level above the first current level during a non-spoke time of the wheel (14).

10. The method of claim 9, wherein increasing the supply current level comprises increasing the supply current level to a level approximately equal to the product of the first current level and a ratio of the spoke time and the non-spoke time.

11. The method of claim 9, wherein decreasing the supply current comprises increasing the supply current to a metal halide lamp (12).

12. The method of claim 9, comprising generating a beam of light from the metal halide lamp (12) using the increased supply current.

13. The method of claim 12, comprising projecting an image onto a screen (20) utilizing the generated beam of light.

14. The method of claim 12, wherein decreasing the supply current level comprises decreasing the supply current level by fifty percent.

15. The method of claim 9, comprising determining a brightness level for a pixel to be projected onto a screen (20) prior to the decreasing on the increasing.

16. A video unit comprising:
means for decreasing a supply current level below a first current level during a spoke time of a color wheel (14); and
means for increasing the supply current level above the first current level during a non-spoke time of the wheel (14).

17. The video unit of claim 16, wherein the means for increasing the supply current level comprises means for increasing the supply current level to a level approximately equal to the product of the first current level and a ratio of the spoke time and the non-spoke time.

18. The video unit of claim 16, wherein the means for decreasing the supply current comprises a metal halide lamp (12).

19. The video unit of claim 16, comprising means for generating a beam of light from the metal halide lamp (12) using the increased supply current.

20. The video unit of claim 19, comprising means for projecting an image onto a screen (20) utilizing the generated beam of light.
